(19) United States
(12) Patent Application Publication
(10) Pub. No.: US 2022/0237307 A1
(43) Pub. Date: Jul. 28, 2022

(54) INFORMATION PROCESSING APPARATUS, INFORMATION PROCESSING SYSTEM, AND APPROVAL SCREEN GENERATION METHOD

(71) Applicant: SONY INTERACTIVE ENTERTAINMENT INC., TOKYO (JP)

(72) Inventors: Yoshihiko SUWA, San Diego, CA (US); Kosuke SUZUKI, TOKYO (JP)

(21) Appl. No.: 17/603,701

(22) PCT Filed: May 1, 2020
(86) PCT No.: PCT/JP2020/018419

§ 371 Date: Oct. 14, 2021

(30) Foreign Application Priority Data
May 9, 2019 (JP) 2019-089001

(51) Int. Cl. G06F 21/62; G06F 21/31

(52) U.S. Cl. CPC G06F 21/629; G06F 2221/2141; G06F 21/31

(57) ABSTRACT

A request acceptance section 160 accepts a use restriction removal request from a user restricted from using a processing target. A screen generation section 164 generates an approval screen for approving the removal request. The screen generation section 164 generates the approval screen including either information regarding an approval of the removal request or information for verifying content of the processing target.

### TECHNICAL FIELD

The present invention relates to a technology for restricting use of a processing target.

### BACKGROUND ART

Information processing apparatuses such as game machines are equipped with a parental control function that allows guardians such as parents to restrict the use of content that may potentially harm children with violent or sexual expressions, for example. In recent years, with their generally prevalent constant access to the Internet, the game machines also permit parental controls on the use of applications for communicating with other users, in addition to restricting the use of content.

### SUMMARY

### Technical Problem

Each country or each region stipulates an age-specific computer game rating system. Japan has set up the CERO (Computer Entertainment Rating Organization), the United States has the ESRB (Entertainment Software Rating Board), and Europe has established the PEGI (Pan European Game Information). These are age-specific rating systems set in accordance with national or regional standards. When parents set rating information corresponding to the age of their children on the game machine, the children are restricted from playing all games of which the target ages exceed the children's.

However, the practice of prohibiting children from playing all games with their target ages exceeding the children's may be considered inflexible. In a case where a child wants to play a particular game title and where his or her parent verifies and approves the content of the game, the restrictions on the use of the game may preferably be removed individually. At this time, the parent should preferably be able to grasp the content of the game solely by the title and instantaneously determine whether to remove the restrictions. In practice, however, there may well be many cases where the content of the games cannot be grasped from their titles alone.

The present invention is thus aimed at providing a technology for supporting removal of use restrictions by parents.

### Solution to Problem

In solving the above problem and according to one embodiment of the present invention, there is provided an information processing apparatus including a screen generation section configured to generate an approval screen for approving a use restriction removal request. The screen generation section generates the approval screen that includes either information regarding an approval of the removal request or information for verifying content of a processing target.

According to another embodiment of the present invention, there is provided an information processing system including: a restriction removal request generation section configured to generate a use restriction removal request based on an operation of a first user restricted from using a processing target; a request acceptance section configured to accept the use restriction removal request; and a screen generation section configured to generate an approval screen for a second user to approve the removal request, the approval screen including either information regarding an approval of the removal request or information for verifying content of the processing target.

According to a further embodiment of the present invention, there is provided an approval screen generation method including a step of generating an approval screen for approving a use restriction removal request, the approval screen including either information regarding an approval of the removal request or information for verifying content of a processing target.

Where other combinations of the above-outlined composing elements or the above expressions of the present invention are converted between different forms such as between a method, an apparatus, a system, a recording medium, and a computer program, they still constitute effective embodiments of this invention.

### BRIEF DESCRIPTION OF DRAWINGS

FIG. 1 is a diagram depicting an information processing system according to one embodiment.

FIG. 2 is a diagram depicting a hardware configuration of a first information processing apparatus.

FIG. 3 is a diagram depicting functional blocks of the first information processing apparatus.

FIG. 4 is a diagram depicting functional blocks of a second information processing apparatus.

FIG. 5 is a diagram depicting an example of a home screen.

FIG. 6 is a diagram depicting an example of a screen that notifies a user of use restrictions.

FIG. 7 is a diagram depicting an example of a restriction removal request approval screen.

FIG. 8 is a diagram depicting another example of the restriction removal request approval screen.

### DESCRIPTION OF EMBODIMENT

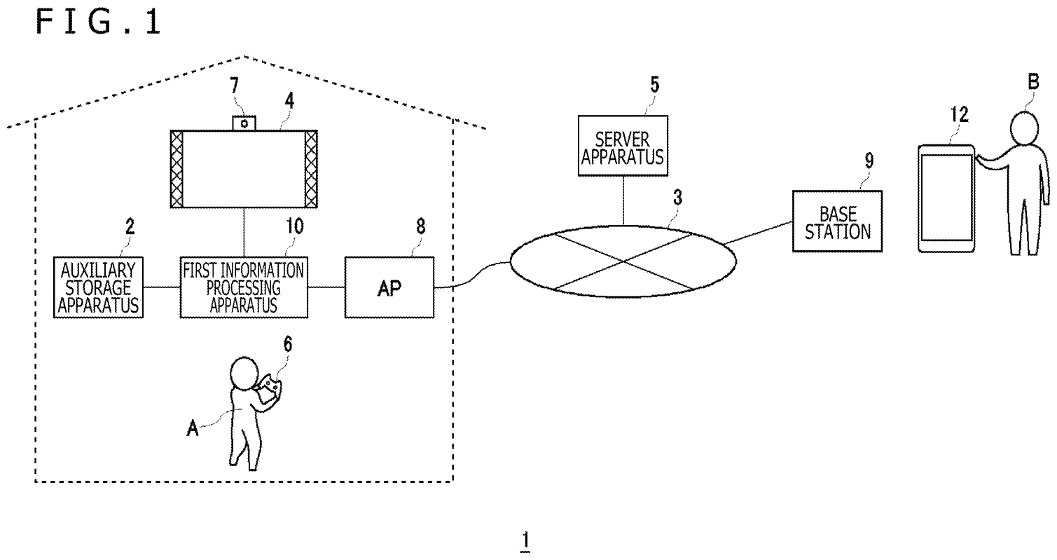

FIG. 1 depicts an information processing system 1 as one embodiment of the present invention. The information processing system 1 includes a first information processing apparatus 10 used by a user A, a second information processing apparatus 12 used by a user B, and a server apparatus 5. The first information processing apparatus 10 is a game machine equipped with a parental control function. The first information processing apparatus 10 may be either a non-portable or a portable type. For this embodiment, it is assumed that the user A is a 17-year-old child and the user B is his or her parent. The user B has the right to set the parental control function. The user B thus sets rating information corresponding to the age of the user A on the first information processing apparatus 10.

The first information processing apparatus 10 is connected in a wired or wireless manner with an input apparatus 6 operated by the user A. The input apparatus 6 outputs operating information input by the user A to the first information processing apparatus 10. Upon acceptance of the operating information from the input apparatus 6, the first information processing apparatus 10 causes the received information to be reflected in processing of system software or game software. The first information processing apparatus 10 causes an output apparatus 4 to output the result of the processing.

The user A is restricted from using a processing target with its target age exceeding the settings in the rating information. The rating information may be either a target age itself as defined according to CERO standards, for example, or setting information associating the target age with a level value for the parental control function. The processing targets of which the use is restricted by the rating information include game content and video content. Besides restricting the use of content by the user A according to the rating information, the user B may further restrict use of applications such as communication applications.

The second information processing apparatus 12 may be a portable terminal apparatus such as a mobile phone, a smartphone, or a tablet. Using the second information processing apparatus 12, the user B can remotely set or modify the parental control function of the first information processing apparatus 10. For example, when the user A generates a use restriction removal request with respect to a processing target of which the use is restricted on the first information processing apparatus 10, the user B using the second information processing apparatus 12 may approve the removal request to let the user A use the processing target. Alternatively, the user B may operate the input apparatus 6 to approve the removal request on the first information processing apparatus 10.

An auxiliary storage apparatus 2 is a mass storage apparatus such as an HDD (hard disc drive) or an SSD (solid-state drive). The auxiliary storage apparatus 2 may be either a built-in storage apparatus or an external storage apparatus connected to the first information processing apparatus 10 via a USB (universal serial bus), for example. The output apparatus 4 may be a television set that has a display device for outputting images and a speaker for outputting sounds. Alternatively, the output apparatus 4 may be a head-mounted display. The output apparatus 4 is connected to the first information processing apparatus 10 either wirelessly or by cable.

A camera 7, which acts as an imaging apparatus, is set up near the output apparatus 4 to capture a space around the output apparatus 4. While FIG. 1 depicts an example in which the camera 7 is mounted on the top of the output apparatus 4, the camera 7 may be arranged instead on the side of the output apparatus 4. In any case, the camera 7 is positioned in a manner capturing the user A playing games in front of the output apparatus 4. The camera 7 may be a stereo camera.

An access point (referred to as the AP hereunder) 8 has functions of a wireless access point and a router. The first information processing apparatus 10 is connected to the AP 8 wirelessly or by cable to connect communicably with the server apparatus 5 on a network 3.

The server apparatus 5 offers network services to the users of the information processing system 1. The users A and B are offered various services while in a state of constantly signing in to the server apparatus 5.

The server apparatus 5 of the embodiment manages a whitelist in which processing targets usable by the user A are registered. The whitelist includes information identifying processing targets of which the use restrictions are individually removed by the user B from among processing targets of which the use by the user A is restricted on the first information processing apparatus 10 by the rating information, for example. The first information processing apparatus 10 and the server apparatus 5 are basically in a state of constant connection with each other. The whitelist is held synchronously between the server apparatus 5 and the first information processing apparatus 10.

Upon receipt of a use restriction removal request from the user A of the first information processing apparatus 10, the server apparatus 5 notifies the second information processing apparatus 12 of the received request. The notification from the server apparatus 5 is transmitted to the second information processing apparatus 12 via a base station 9. Upon receipt of a use restriction removal approval from the user B of the second information processing apparatus 12, the server apparatus 5 updates the whitelist and notifies the first information processing apparatus 10 of the updated content of the whitelist.

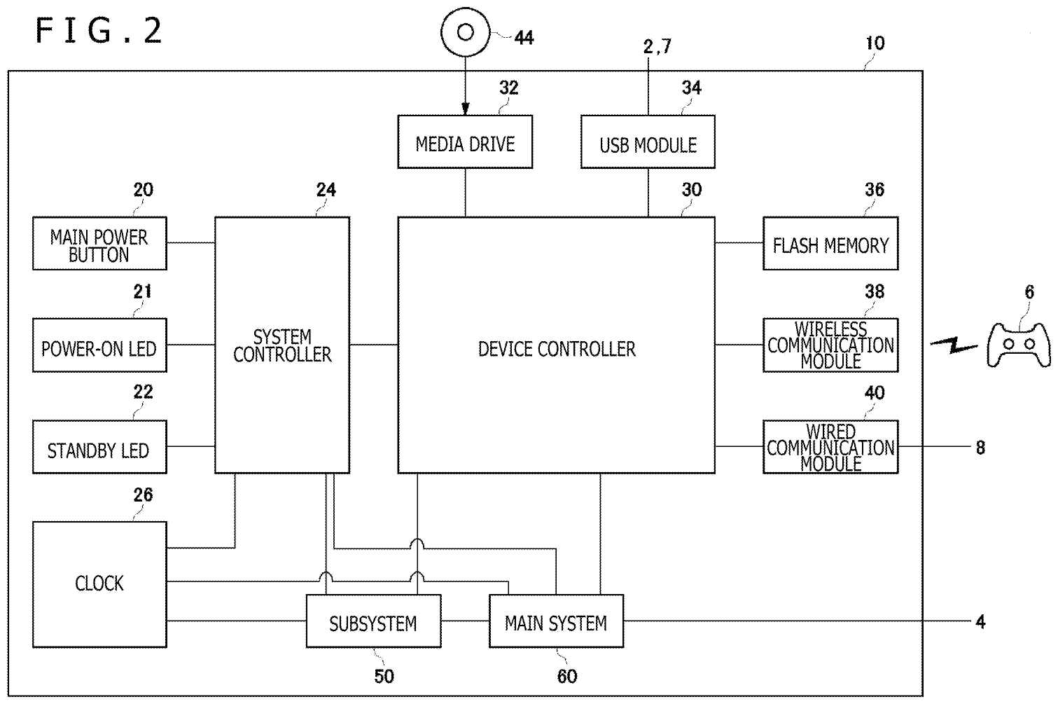

FIG. 2 depicts a hardware configuration of the first information processing apparatus 10. The first information processing apparatus 10 includes a main power button 20, a power-ON LED (light emitting diode) 21, a standby LED 22, a system controller 24, a clock 26, a device controller 30, a media drive 32, a USB module 34, a flash memory 36, a wireless communication module 38, a wired communication module 40, a subsystem 50, and a main system 60.

The main system 60 includes a main CPU (central processing unit), a memory acting as a main storage with a memory controller, and a GPU (graphics processing unit). The GPU is used primarily for arithmetic processing of game programs. These functions may be configured as a system-on-chip constituted of a single chip. The main CPU has a function of executing game programs recorded in the auxiliary storage apparatus 2.

The subsystem 50 includes a sub CPU and a memory acting as a main storage with a memory controller. The subsystem 50 does not include a GPU and has no function of executing game programs. The number of circuit gates in the sub CPU is smaller than the number of circuit gates in the main CPU. The operating power consumption of the sub CPU is lower than that of the main CPU. The sub CPU has its processing functions limited such that it may remain active on low power while the main CPU is in a standby state.

The main power button 20 is an input section on which the user performs an operation input. The main power button 20 is located on a front surface of a housing of the first information processing apparatus 10 and is used to turn on or off supply of power to the main system 60 of the first information processing apparatus 10. The power-ON LED 21 is lit when the main power button 20 is turned on. The standby LED 22 is lit when the main power button 20 is turned off.

The system controller 24 detects pressing of the main power button 20 by the user. When the main power supply is in an off-state, pressing the main power button 20 causes the system controller 24 to acquire the pressing operation as an “ON instruction.” When the main power supply is in an on-state, pressing the main power button 20 causes the system controller 24 to acquire the pressing operation as an “OFF instruction.”

The clock 26 is a real time clock. The clock 26 generates current date and time information and supplies the generated information to the system controller 24, to the subsystem 50, and to the main system 60. The device controller 30 is configured as an LSI (large-scale integrated circuit) that, like a Southbridge, mediates exchanges of information between devices. As illustrated, the device controller 30 is connected with such devices as the system controller 24, the media drive 32, the USB module 34, the flash memory 36, the wireless communication module 38, the wired communication module 40, the subsystem 50, and the main system 60. The device controller 30 absorbs differences in electrical characteristics and data transfer rates between the devices in order to control timings of data transfer therebetween.

The media drive 32 is a drive apparatus to be loaded with a ROM (read only memory) medium 44 on which software such as games and their license information are recorded. The media drive 32 drives the loaded ROM medium 44 to read programs and data therefrom. The ROM medium 44 is a read-only recording medium such as an optical disc, a magneto-optical disc, or a Blu-ray disc.

The USB module 34 is a module for connection with an external device by a USB cable. The USB module 34 may be connected with the auxiliary storage apparatus 2 and with the camera 7 by USB cables. The flash memory 36 is an auxiliary storage apparatus that constitutes an internal storage. The wireless communication module 38 communicates wirelessly with the input apparatus 6, for example, according to communication protocols such as the Bluetooth (registered trademark) protocol or the IEEE (Institute of Electrical and Electronics Engineers) 802.11 protocol. Alternatively, the wireless communication module 38 may support a digital mobile phone system. The wired communication module 40 communicates by wire with an external device, and connects with the external network 3 via the AP 8, for example.

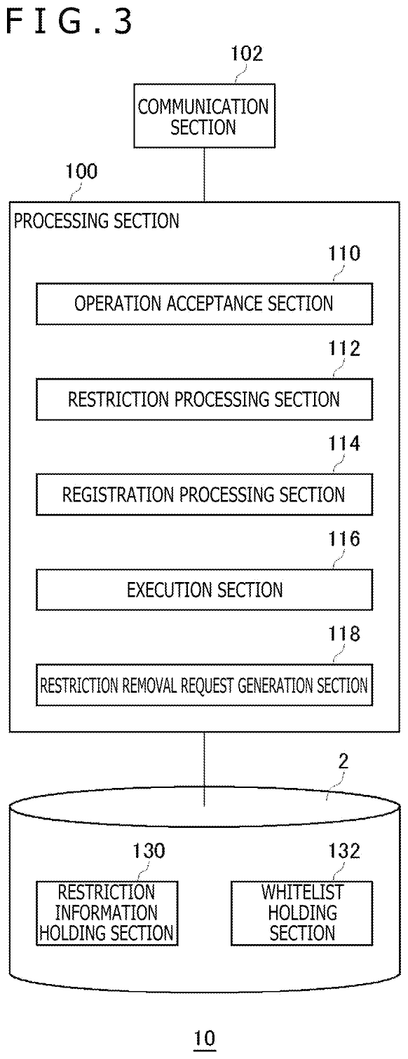

FIG. 3 depicts functional blocks of the first information processing apparatus 10. The first information processing apparatus 10 includes a processing section 100 and a communication section 102. The processing section 100 includes an operation acceptance section 110, a restriction processing section 112, a registration processing section 114, an execution section 116, and a restriction removal request generation section 118. The communication section 102 includes the functions of the wireless communication module 38 and the wired communication module 40 depicted in FIG. 2. The auxiliary storage apparatus 2 includes a restriction information holding section 130 that holds restriction information and a whitelist holding section 132 that holds information identifying the processing targets of which the use restrictions are removed for the user A. In the whitelist holding section 132, the whitelist records information identifying the processing targets of which the use is not restricted.

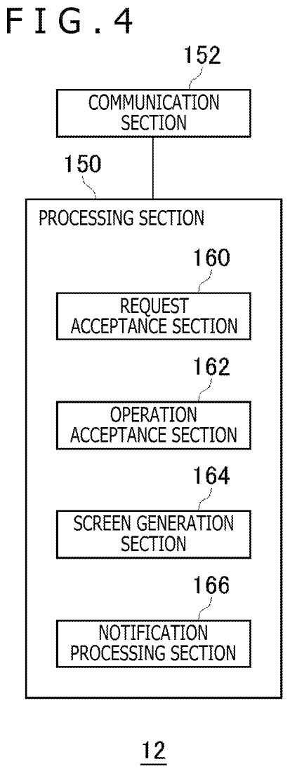

FIG. 4 depicts functional blocks of the second information processing apparatus 12. The second information processing apparatus 12 includes a processing section 150 and a communication section 152. The processing section 150 includes a request acceptance section 160, an operation acceptance section 162, a screen generation section 164, and a notification processing section 166. The communication section 152 of the embodiment is configured as a wireless communication module communicating with the base station 9 via mobile phone lines. The communication section 152 may also include a wireless LAN (local area network) communication function. While the second information processing apparatus 12 of the embodiment is assumed to be a mobile terminal apparatus, the second information processing apparatus 12 may alternatively be a non-portable terminal apparatus. In this case, the communication section 152 may be connected by wire to the network 3.

The elements depicted as the functional blocks for performing various processes in FIGS. 3 and 4 may be configured by hardware using circuit blocks, memories, and other LSIs, or by software using programs loaded into a memory. It will thus be appreciated by those skilled in the art that these functional blocks can be implemented by hardware only, by software only, or by a combination thereof in diverse forms and are not limited to any one of such forms.

The restriction information holding section 130 holds rating information set for the user A. The user B may, on his or her discretion, approve use of content with a target age older than that of the user A. Since the user A is 17 years old for the embodiment, the user B registers in the restriction information holding section 130 restriction information made up of the rating information restricting the use of content with a target age of at least 18. The user B may further restrict the use by the user A of specific applications such as communication applications. The restriction information holding section 130 may thus hold information identifying the restricted applications. In this manner, the restriction information holding section 130 holds the restriction information regarding the processing targets that the user A is restricted from using.

The whitelist holding section 132 writes to the whitelist the information identifying the processing targets of which the restrictions are individually removed by the user B from among the processing targets of which the use is restricted for the user A. That is, the whitelist records the information identifying the processing targets of which the use is restricted by the restriction information held in the restriction information holding section 130 but of which the restrictions are removed by the user B having approved the use restriction removal request from the user A. For example, although a game title C with a target age of at least 18 is restricted for use by the user A according to the rating information, if the whitelist includes information identifying the game title C, then the user A can play the game title C.

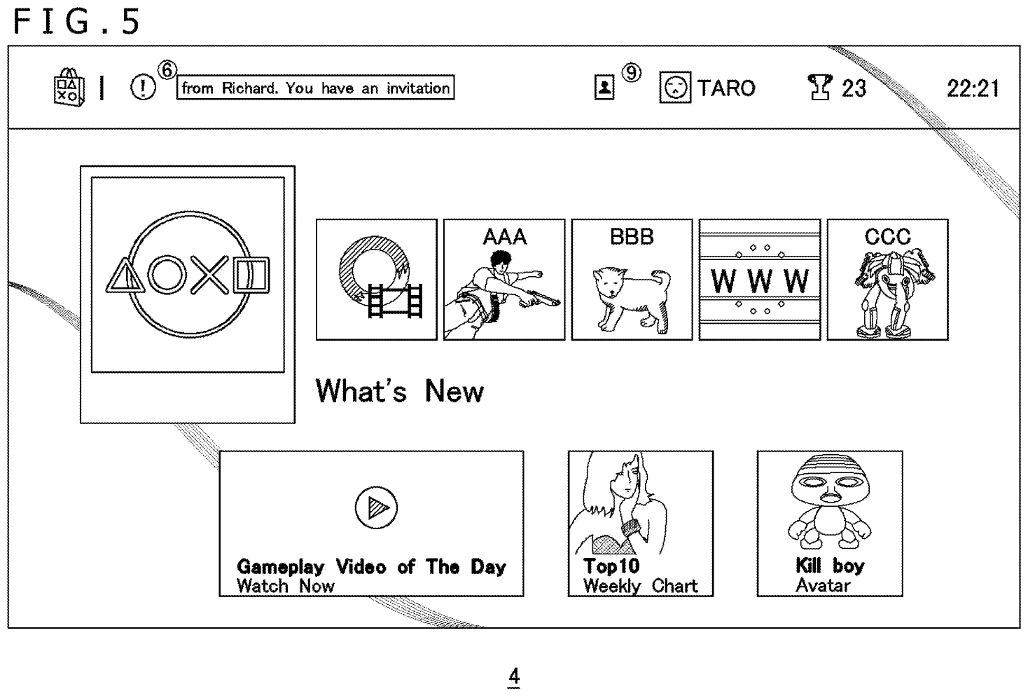

FIG. 5 depicts an example of a home screen for the user A (TARO) as displayed on the output apparatus 4. The home screen includes an icon display area in which multiple game icons are arranged laterally. By operating a right key or a left key of the input apparatus 6, the user A scrolls the game icons crosswise in the icon display area to select a game icon of a game title A. With the game icon of the game title A selected, the user A operates an Enter button of the input apparatus 6. This causes the restriction processing section 112 to determine whether to approve or restrict starting of the game title A before the execution section 116 executes the game title A.

The restriction processing section 112 determines whether the use of the game title A requested to be started is restricted by referencing the restriction information held in the restriction information holding section 130. Upon determining that the use of the game title A is not restricted by the restriction information, the restriction processing section 112 approves the starting of the game and allows the execution section 116 to activate the game. In a case where the use of the game title A is restricted by the restriction information, the restriction processing section 112 references the whitelist held in the whitelist holding section 132 to determine whether the use of the game title A is individually approved. In a case where the whitelist includes identification information (game ID) regarding the game title A, the restriction processing section 112 approves the starting of the game title A and allows the execution section 116 to activate the game.

On the other hand, in a case where the game ID of the game title A is not included in the whitelist, the restriction processing section 112 determines that the use of the game is restricted and prohibits the execution section 116 from starting the game.

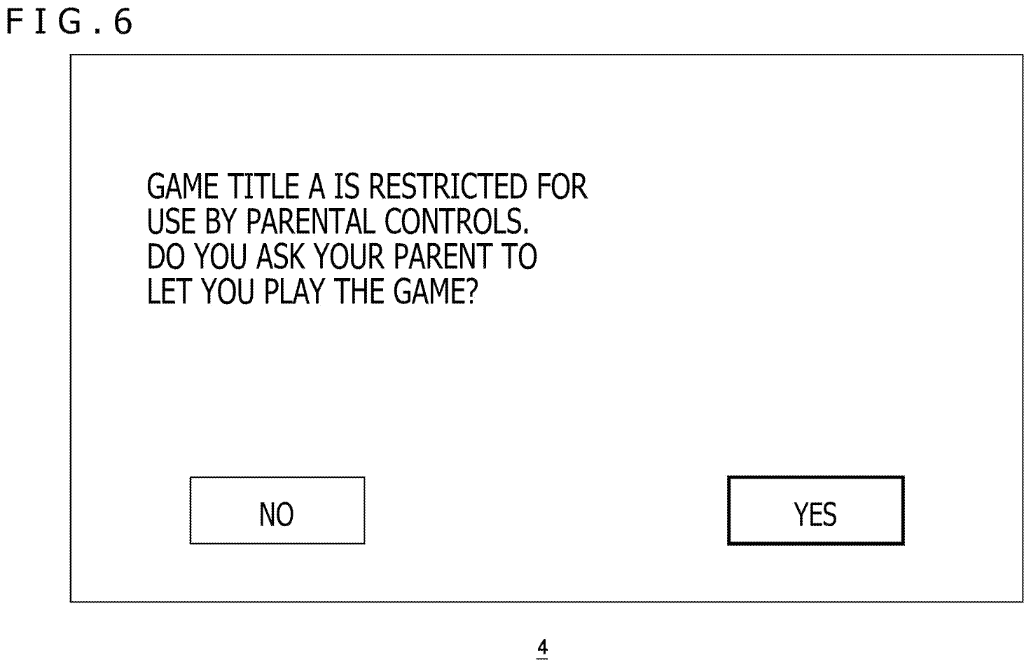

FIG. 6 depicts an example of a screen for notifying the user A that the use of the game is restricted. After determining that the game title A is restricted for use, the restriction processing section 112 displays on the screen a notification saying that the game cannot be started. The notification screen displays two alternatives: give up playing the game, or ask the parent for approval. If the user A selectively operates a “No” button on the notification screen, the display screen returns to the home screen. If the user A selectively operates an “Yes” button, the restriction removal request generation section 118 generates a use restriction removal request, and the communication section 102 transmits the generated request to the server apparatus 5. The removal request includes at least the information (game ID) identifying the game.

The server apparatus 5 holds an address of the second information processing apparatus 12 that is a destination of the removal request from the user A. Upon receipt of the use restriction removal request from the user A, the server apparatus 5 reads the address of the second information processing apparatus 12 constituting the destination, and transmits the use restriction removal request to the second information processing apparatus 12.

In the second information processing apparatus 12, the communication section 152 receives the use restriction removal request, and the request acceptance section 160 accepts the use restriction removal request. Upon acceptance of the removal request by the request acceptance section 160, the notification processing section 166 notifies the user B that the removal request is accepted. The notification may be displayed on a display of the second information processing apparatus 12 indicating that the removal request is accepted. Alternatively, the notification may be given as vibrations of the second information processing apparatus 12 indicating the arrival of the notification. Thus notified, the user B recognizes that the use restriction removal request is received from the user A.

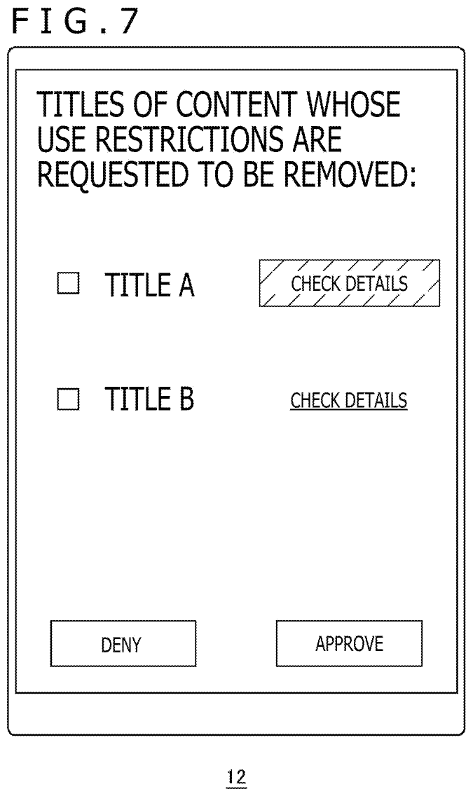

FIG. 7 depicts an example of a restriction removal request approval screen. The server apparatus 5 transmits to the second information processing apparatus 12 data for generating an approval screen for approving a removal request. Upon receipt of the data, the screen generation section 164 generates the approval screen. The approval screen depicted in FIG. 7 is generated on the basis of the restriction removal request with respect to the game title A and a game title B. The removal request regarding the game title B was previously generated. Since the user B has not worked on the approval of the game title B, the approval screen in FIG. 7 displays the restriction removal request not only with respect to the title A but also regarding the title B. In order to let the user B know when the use restriction removal request was generated, the date and time at which the use restriction removal request was generated may be displayed near each title name.

If the user B can grasp the content of the games by simply glancing at the title A and the title B and determines that their use restrictions may be removed, the user B checks a checkbox for each title and selectively operates an “Approve” button. The operation acceptance section 162 accepts the operation of the user B, and causes the communication section 152 to transmit the information selected by the user B to the server apparatus 5. In turn, the server apparatus 5 adds the game IDs of the title A and the title B to the whitelist for an update. The server apparatus 5 further notifies the first information processing apparatus 10 of the updated content of the whitelist. This enables the user A to use each game title.

However, the user B may not be able to grasp the content of the games by glancing at the title A and the title B. In order to support the user B in recognizing the game content, the approval screen provides a “Check details” button. By selectively operating the “Check details” button, the user B can view detailed information regarding each title.

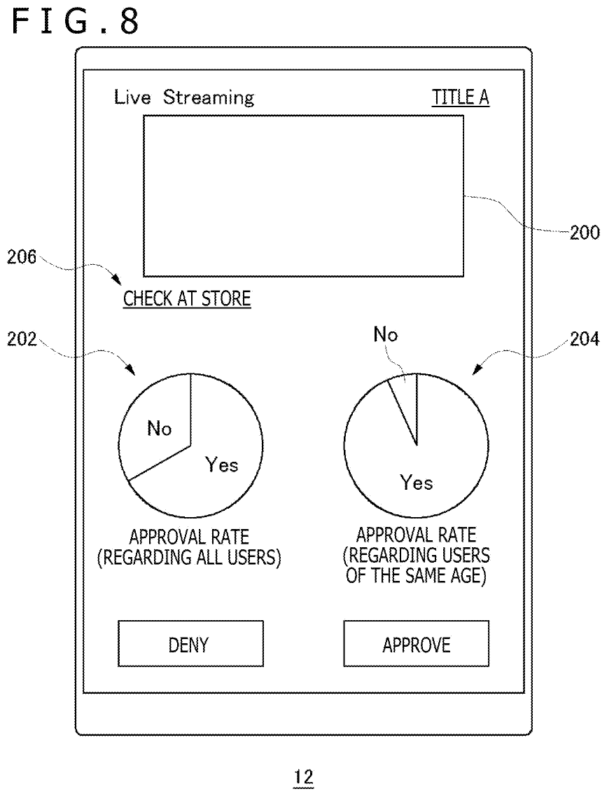

FIG. 8 is a diagram depicting another example of the restriction removal request approval screen. When the user B selectively operates the “Check details” button for the title A, the operation acceptance section 162 transmits operation information regarding the “Check details” button to the server apparatus 5 via the communication section 152. The server apparatus 5 transmits to the second information processing apparatus 12 data for the second information processing apparatus 12 to generate the approval screen. Upon receipt of the data, the screen generation section 164 generates the approval screen for approving the use restriction removal request with respect to the title A. At this time, the screen generation section 164 generates the approval screen that includes information regarding the approval of the removal request and/or information for verifying the content of the processing target.

The screen generation section 164 causes the approval screen to include information regarding past records of removal request approvals as the information regarding the current removal request approval. On the approval screen in FIG. 8, past record information 202 indicates an approval rate at which the requests to remove the use restriction of the title A were approved previously. Verifying the past record information 202 allows the user B to know the statistics indicative of how other parents made the determination in the past. This can help contribute to determining whether to approve the current removal request from the user A.

Past record information 204 indicates an approval rate at which the removal requests generated by users of the same age as the user A with respect to the title A were approved previously. While the past record information 202 indicates overall statistical values, the past record information 204 gives the statistics indicative of how other parents having children of the same age as the child of the user B made the determination. This can provide a more useful material for the user B in making the determination. Preferably, the server apparatus 5 may generate the past record information 202 from the information identifying the game and included in the removal request, and generate the past record information 204 from the age of the user A, before sending the generated information to the second information processing apparatus 12.

The screen generation section 164 may let the approval screen include a store link 206 to a store page that markets the game title A. The store page of the title A includes diverse information regarding the title A, such as explanations of details of the game, an official trailer, and official screen shots. Thus the store link 206 may be displayed in order to let the user A view the store page easily. The screen generation section 164 may further allow the approval screen to include results of automatic searches by browsers or video distribution sites by using the title A as a key. The screen generation section 164 may also let the approval screen include links for viewing the results of the automatic searches.

The screen generation section 164 may allow the approval screen to include a moving image display area 200 for displaying a moving image of the processing target as information for verifying the content of the processing target. The moving image display area 200 may provide streaming reproduction of a moving image of the game currently played by another user. By viewing the moving image of the game, the user B can recognize what kind of game it is and grasp the content of the game. The moving image display area 200 may further display a demonstration moving image produced by a game maker, or moving images of the game played by other users in the past and archived in the server apparatus 5. In any case, the moving image display area 200 displays moving images that help the user B understand the content of the game. Alternatively, the moving image display area 200 may display still images for allowing the content of the game to be grasped.

By referencing the information displayed on the approval screen depicted in FIG. 8, the user B determines whether to approve the game play of the title A by the user A. In the case of approving the game play, the user B selectively operates the “Approve” button. The operation acceptance section 162 accepts the operation of the user B, and causes the communication section 152 to transmit to the server apparatus 5 information indicating that the “Approve” button has been operated. This causes the server apparatus 5 to add the game ID of the game title A to the whitelist for an update and notify the first information processing apparatus 10 of the updated content of the whitelist. In a case where the first information processing apparatus 10 cannot receive the notification from the server apparatus 5 because the first information processing apparatus 10 is being switched off, for example, the server apparatus 5 may notify the first information processing apparatus 10 of the updated content of the whitelist whenever the first information processing apparatus 10 becomes ready to receive such notifications from the server apparatus 5.

In the first information processing apparatus 10, the registration processing section 114 adds the game ID of the game title A to the whitelist held in the whitelist holding section 132. That is, the registration processing section 114 registers in the whitelist the game ID of the game title A as the processing target approved by the user B. This allows the restriction processing section 112 to remove the restrictions on starting the game title A, thereby enabling the user A to activate the game title A.

The present invention has been described above in conjunction with a specific embodiment. It is to be understood by those skilled in the art that suitable combinations of the constituent elements and of various processes of the embodiment described above as examples will lead to further variations of the present invention and that such variations also fall within the scope of this invention. While the first information processing apparatus 10 of the above embodiment is a non-portable game machine, the first information processing apparatus 10 may alternatively be a cloud server that provides cloud gaming services to the user A.

### INDUSTRIAL APPLICABILITY

The present invention may be used in technical fields that manage use restrictions.

### REFERENCE SIGNS LIST

1: Information processing system
10: First information processing apparatus
12: Second information processing apparatus
100: Processing section
102: Communication section
110: Operation acceptance section
112: Restriction processing section
114: Registration processing section
116: Execution section
118: Restriction removal request generation section
130: Restriction information holding section
132: Whitelist holding section
150: Processing section
152: Communication section
160: Request acceptance section
162: Operation acceptance section
164: Screen generation section
166: Notification processing section

1.-9. (canceled)

10. An information processing apparatus comprising:
a screen generation section configured to generate an approval screen for approving a removal request for removing use restrictions of a processing target,
wherein the screen generation section generates a first approval screen including a name of the processing target, and a second approval screen including either information regarding an approval of the removal request or information for verifying content of the processing target.

11. The information processing apparatus according to claim 10, further comprising: a request acceptance section configured to accept the use restriction removal request from a user restricted from using the processing target.

12. The information processing apparatus according to claim 10, wherein the screen generation section generates the second approval screen that includes information regarding a past record of approvals of the removal request.

13. The information processing apparatus according to claim 12, wherein the information regarding the past record includes an approval rate at which removal requests generated by other users of a same age as the user were approved in the past.

14. The information processing apparatus according to claim 10, wherein the screen generation section generates a second approval screen including an area for displaying a moving image of the processing target.

15. The information processing apparatus according to claim 10, wherein the screen generation section generates the first approval screen, before generating the second approval screen.

16. The information processing apparatus according to claim 15, wherein the screen generation section generates the second approval screen after a user of this information processing apparatus has performed a predetermined operation on the first approval screen.

17. The information processing apparatus according to claim 10, wherein the screen generation section generates the first approval screen that includes a date and time at which the use restriction removal request was generated.

18. The information processing apparatus according to claim 10, wherein the screen generation section generates the first approval screen that includes names of a plurality of processing targets.

19. An information processing system comprising:
a restriction removal request generation section configured to generate a use restriction removal request based on an operation of a first user restricted from using a processing target;
a request acceptance section configured to accept the use restriction removal request; and
a screen generation section configured to generate a first approval screen for a second user to approve the removal request, the first approval screen including a name of the processing target, the screen generation section further generating a second approval screen that includes either information regarding an approval of the removal request or information for verifying content of the processing target.

20. The information processing system according to claim 19, further comprising:
a registration processing section configured to register the processing target approved by the second user in a whitelist that records information identifying processing targets of which use restrictions are removed.

21. An approval screen generation method comprising:
generating a first approval screen for approving a use restriction removal request, the first approval screen including a name of a processing target; and
generating a second approval screen for approving the use restriction removal request, the second approval screen including either information regarding an approval of the removal request or information for verifying content of the processing target.

22. A program for a computer, comprising:
by a screen generation section,
generating a first approval screen for approving a use restriction removal request, the first approval screen including a name of a processing target; and
generating a second approval screen for approving the use restriction removal request, the second approval screen including either information regarding an approval of the removal request or information for verifying content of the processing target.
